(19) United States
(12) Patent Application Publication
(10) Pub. No.: US 2014/0074510 A1
(43) Pub. Date: Mar. 13, 2014

(54) Personalized Health Score Generator

(71) Applicants: Jennifer Clement McClung, Dallas, TX (US); Richard W. Egan, Atlanta, GA (US); Hsi-Ming Li, Marietta, GA (US); Samuel M. Wilkes, Atlanta, GA (US)

(72) Inventors: Jennifer Clement McClung, Dallas, TX (US); Richard W. Egan, Atlanta, GA (US); Hsi-Ming Li, Marietta, GA (US); Samuel M. Wilkes, Atlanta, GA (US)

(21) Appl. No.: 14/020,631

(22) Filed: Sep. 6, 2013

Related U.S. Application Data
(60) Provisional application No. 61/698,008, filed on Sep. 7, 2012.

(51) Int. Cl. G06F 19/00

(52) U.S. Cl. CPC G06F 19/3431
USPC 705/3

(57) ABSTRACT

A computer may receive health related data from a plurality of data sources. Upon receiving the health related data, the computer may standardize the health related data based on a reference database. Further, based on a person-centric data framework, the computer may categorize the health related data into historical health related data and current health related data. Then, the computer may calculate a risk score based on the historical health related data and the current health related data. Once the risk score is calculated, the computer may determine a cost associated with a risk represented by the risk score. Further, the computer may generate a overall health score based on the risk score and the determined cost, which may then be transmitted for presentation to authorized end users.

### CROSS-REFERENCE TO RELATED APPLICATIONS

This application claims priority to U.S. Provisional Patent Application No. 61/698,008 filed Sep. 7, 2012 in the names of Jennifer Clement McClung, Richard W. Egan, Hsi-Ming Lin, and Samuel M. Wilkes and entitled “System and Method for Producing a Personalized Health Risk Score,” the entire contents of which are hereby incorporated herein by reference.

### FIELD OF INVENTION

This disclosure relates generally to a technical field of risk analysis and, in one example embodiment, and in particular to a system, method, and apparatus for personalized health score generation.

### BACKGROUND

The performance of the healthcare industry may be considered inadequate where the cost associated with healthcare continues to escalate with little improvement in the quality of healthcare provided to users. Such slow improvement in the quality of healthcare may be attributed to the inefficiency of conventional technology in consolidating and standardizing health related data from numerous sources, and to foresee health risks associated with the users. The inability to foresee health risks associated with users may inhibit the ability of healthcare providers to provide proactive treatments to users to prevent the occurrence of a serious health problem. Instead, the healthcare providers may be forced to treat users on reactive basis, such as upon manifestation of a serious health problem which may result in additional complications to the user, and which may also prove to be more expensive than focused preventive healthcare. Further, conventional technology may lack the ability to generate consistent set of health metrics based on which viable and beneficial economic decisions can be made within the healthcare industry. The lack of consistent, well-defined, and reliable health metrics may lead to inconsistent, inaccurate, and unreasonable pricing for healthcare services which may be unfair to the users. Thus the inefficiencies of the conventional technologies may affect nearly all the actors within the healthcare industry, such as the healthcare professionals, the healthcare users, health insurance providers, and so on.

Currently certain isolated sectors of the healthcare industry may be capable of determining health risks associated with some users and generating health metrics associated with those users. For example, some insurance entities within the healthcare industry may have internal mechanisms to calculate risk associated with an individual. However, such determinations may be limited to the specific needs of the entity, such as internal to the insurance companies for providing insurance plans, and may be incompatible for seamless use across the entire healthcare industry, which if used may lead to inconsistencies. Further, such determinations that are specific to an entity may be limited to data from a limited number of sources based on the technology capability of the entity. Thus, such health risk determinations that are specific to an entity may be inadequate for being used in general across the industry. Accordingly, there exists a need for technology that cures the above-mentioned deficiencies.

### SUMMARY

The present disclosure supports a method, apparatus, and a system for a personalized health score generator. The personalized health score generator may aid in consolidating any appropriate health related data associated with an individual into a single score that may provide a perspective of individuals health. The personalized health score may be generated based on health care data of a user that has been aggregated from numerous independent and/or interrelated data sources. In other words, the personalized health score may be a distillation of any appropriate health related data received from across multiple industries and accordingly, the personalized health score may be a standardized score that can be seamlessly transferable across different industries, such as health insurance industry, healthcare professional industry, research organizations, and so on. For example, a health score of a person X generated by the present invention may be used by different health insurance companies as a standardized score to determine an appropriate health insurance plan for person X. Further, the same health score may be used by a health care physician to recommend a treatment for person X.

In one aspect, a method of the personalized health score generator may include receiving health related data of a user from a plurality of sources. Further, the method may include aggregating the health related data received from the plurality of sources. Furthermore, the method may include, generating a health score for the user based on the aggregated health related data. In addition, the method may include providing access to the health score.

In another aspect, an apparatus may include a memory comprising a set of instructions, and a processor coupled to the memory. The processor may be configured to execute the set of instructions to receive health related data of a user from a plurality of sources. Further, the processor may be configured to categorize the health related data into a category of historical health related data and a category of current health related data. Then the processor may be configured to generate a health score for the user based on the historical health related data and the current health related data. In addition, the processor may be configured to transmit the health score for presentation by a computing device of either the user or another user.

In yet another aspect, a system may include a communication network, and a computer coupled to the communication network. The computer may be configured to receive health related data of a user from a plurality of sources. Further, the computer may be configured to aggregate the health related data received from the plurality of sources in a database. In addition, the computer may be configured to generate a health score for the user based on the health related data that is aggregated in the database.

The discussion of the personalized health score generator in this summary is for illustrative purposes only. Various aspects of the present invention may be more clearly understood and appreciated from a review of the following detailed description of the disclosed embodiments and by reference to the drawings and the claims that follow. Moreover, other aspects, systems, methods, features, advantages, and objects of the present invention will become apparent to one with skill in the art upon examination of the following drawings and detailed description. It is intended that all such aspects, systems, methods, features, advantages, and objects are to be included within this description, are to be within the scope of the present invention, and are to be protected by any accompanying claims.

### BRIEF DESCRIPTION OF THE FIGURES

Example embodiments are illustrated by way of example and not limitation in the figures of the accompanying drawings, in which:

FIG. 1 illustrates an example personalized health score generator system, according to certain exemplary embodiments of the present invention.

FIG. 2 illustrates example input data sources associated with the personalized health score generator system, according to certain exemplary embodiments of the present invention.

FIG. 3 illustrates an example functional block diagram of the health score server, according to certain exemplary embodiments of the present invention.

FIG. 4 illustrates an example functional block diagram of the health score generator engine of the health score server illustrated in FIG. 3, according to certain exemplary embodiments of the present invention.

FIG. 5 illustrates an example organization of data based on a user-centric data framework, according to certain exemplary embodiments of the present invention.

FIG. 6 is a flow chart that illustrates a process of generating a personalized health score, according to certain exemplary embodiments of the present invention.

FIG. 7 is a flow chart that illustrates a process of building the repository, according to certain exemplary embodiments of the present invention.

FIGS. 8A-8B (collectively ‘FIG. 8’) is a flow chart that illustrates a process of calculating the health score, according to certain exemplary embodiments of the present invention.

Many aspects of the invention can be better understood with reference to the above drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the Detailed Description that follows.

### DETAILED DESCRIPTION

Disclosed are a system, a method and an apparatus for generating a personalized health score. Before discussing the embodiments directed to the personalized health score generator, it may assist the reader to understand the various terms used herein by way of a general description of the terms in the following paragraphs.

The term ‘health related data,’ as used herein may generally refer to any appropriate medical and/or non-medical data that is associated with the health of a person. In one example embodiment, the health related data may include any appropriate data that directly and/or indirectly affects the health of the person. For example, the health related data may include medical and/or clinical data associated with the person, such as blood sugar level of the patient, blood pressure level of the patient, scan results, heart monitor data of the patient, and so on. In another example, the health related data may include indirect factors that could affect the present health of a person or the health of the person in the near-future, and in a long term, such as environmental factors, activity level of the person, work environment of the person, spiritual inclination of the person, mental and emotional health of the person, diet of the person, and so on. In another example, the indirect factors may include the demographics of the person such as age, gender, race, and so on. One of ordinary skill in the art can understand and appreciate that the above-mentioned examples are not exhaustive, and the health related data can include any appropriate number, and type of data that have a high and/or low correlation with the health of a human being. Further, in this disclosure, the terms ‘health related data,’ may also be referred to as ‘health data,’ and may be interchangeably used without departing from the broader scope of the disclosure.

The term ‘historical health related data,’ as used herein may generally refer to any appropriate medical history data and/or non-medical history data associated with the health of a person. Without being exhaustive, a few representative examples of historical health related data may include, inter alia, existing conditions, family medical history of the person, gene structure of the person, a social history of the person, and so on. In some embodiments, the historical health related data can include demographics data associated with the person. For example, date of birth (age), gender, race, and so on. In this disclosure, the terms ‘historical health related data,’ may also be referred to as ‘static health data,’ and may be interchangeably used without departing from the broader scope of the disclosure.

The term ‘current health related data,’ as used herein may generally refer to any appropriate health related data of a person other than the historical health related data. In one example embodiment, the current health related data may refer to current medical and/or non-medical data (e.g., other than the historical health data) that may provide a current perspective of the wellness and health of a person. For example, the vital signs (physiological statistics) of a person which may include, but not limited to, reading of blood sugar level, body temperature, body weight, blood pressure level, heart rate, and so on, which may change frequently based on daily activity of the person. In another example, current health related data may include, but not limited to, data representative of socialization, medication adherence, environment, behavior, habits, spiritual life, exercise level, diet and nutrition, and so on. In another example embodiment, the current health related data may include data related to the health of a person that is frequently monitored and refreshed. The frequency of monitoring and refreshing the data may vary based on different scenarios. For example, if the person is admitted in an acute care hospital, the health data may be monitored and refreshed on a daily basis. However, if the patient is healthy, then the data may be monitored and refreshed at a lower rate, such as on a monthly or annual basis when the person makes a visit to a doctor for monthly or yearly checkup. In this disclosure, the terms ‘current health related data,’ may also be referred to as ‘dynamic health data,’ and may be interchangeably used without departing from the broader scope of the disclosure.

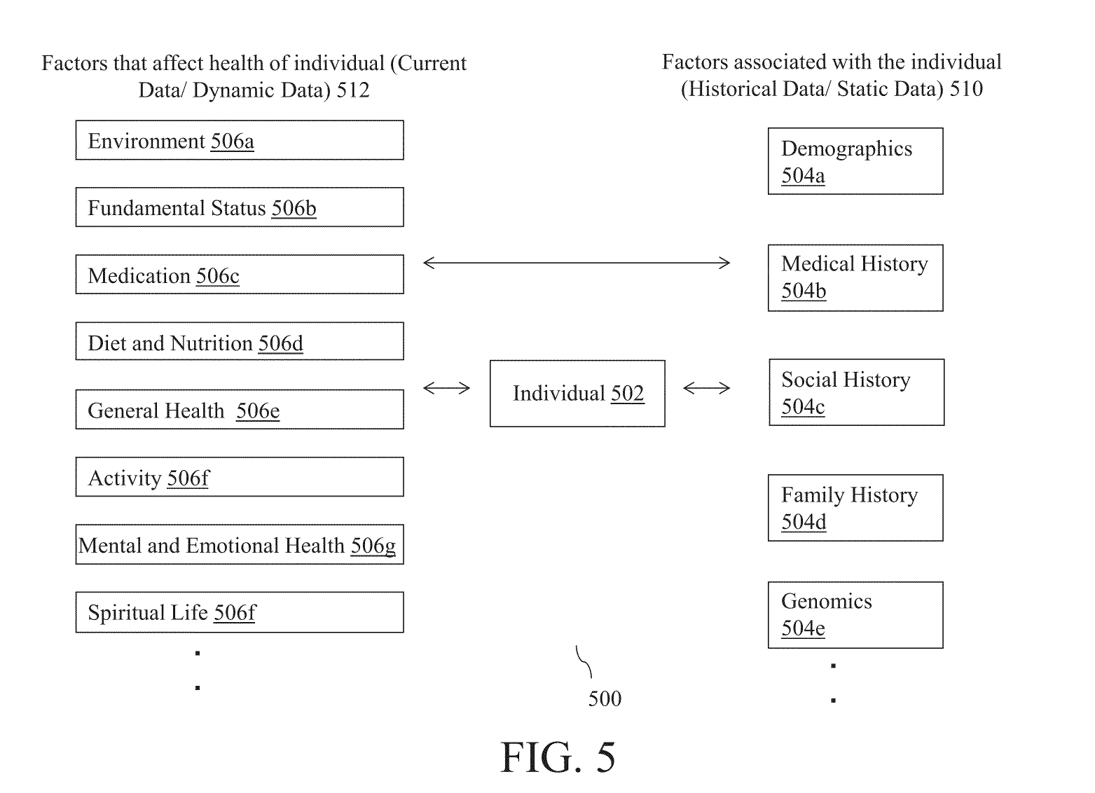

The term ‘user-centered data framework,’ as used herein may generally refer to any appropriate data framework for organization of data, wherein the data is organized such that it is centered around or based on the person. One example embodiment of the ‘user centered data categories’ may be described below in greater detail in association with FIG. 5. The number of categories and the type of categories into which the data is organized may be defined based on the type of analysis that is to be performed on the data. Further, the categories may be user settable or settable by a computing system based on user preferences and/or data analytics desired by the user.

The term ‘risk score,’ as used herein may generally refer to any appropriate expression of a predicted risk for manifestation of a health event associated with a person. Further, the risk score may also be representative of a relative risk for manifestation of one or more health events in the person.

The term ‘health event’ as used herein may generally refer to any appropriate incidents associated with the health of a person. In one embodiment, the health event may include any abnormal function of any appropriate part of a human body. For example, the health event can include a stroke, hypertension, hypotension, bone fracture, heart diseases, lung diseases, kidney failure, diabetes, and so on. One of ordinary skill in the art can understand and appreciate that the above-mentioned examples of health events are not exhaustive, and can include any appropriate number and type of incidents associated with the health of a human being without departing from the broader spirit of the disclosure.

The term ‘cost associated with the risk,’ as used herein may generally refer to any appropriate expense associated with addressing a health event anticipated by the risk score. In other words, the cost associated with the risk may represent a projected cost of a predicted risk. In one embodiment, the cost associated with the risk may be a monetary cost associated with addressing a health event anticipated by the risk score. For example, the cost of treating an ischemic stroke, cost of being admitted in an intensive care unit, cost of using scanning machine and other hospital facilities needed for treatment of the ischemic stroke. In another embodiment, the cost associated with the risk may be non-monetary, such as man-power hours, supportive care, emotional stress, and so on.

The term ‘health score,’ as used herein may include an expression representative of any appropriate combination of the risk score and the cost associated with the risk. In one example, such combination may include a structured ranking of the risk score representative of risk of one or more health events by the anticipated cost of treatment of the health events. In one embodiment, a confidence level may be provided along with the health score, wherein the confidence level may be based on the quality, quantity, and/or scope of the data. In one example embodiment, the health score may be represented numerically, such as a numerical expression. For example, the health score may range from 0-10, 0-100, 0-800, 50-900, etc. In another example embodiment, the health score may be represented textually, such as an alphabetic expression. For example, the health score may be range from A-F with A representative of least risk and F representative of highest risk, or vice versa. In yet another example embodiment, the health score may be represented by a combination of numbers and texts, such as an alphanumeric expression. Further, in another example embodiment, the health score may be represented as a symbol. For example, the risk score may be represented using stars, wherein 5 stars represent good health condition and low risk and 1 star represents a poor health condition and high risk.

A personalized health score generator system may include a server that is configured to receive health related data associated with one or more individuals from a plurality of data sources. Upon receiving the health related data, the server may be configured to standardize the received health related data and categorize, for each individual, the standardized data into categories representative of historical health data and categories representative of current health data based on a user-centric data framework. Further, the standardized data may be stored within their respective categories in a database.

Once the data is standardized, categorized, and stored in the database, the server may be configured to automatically process the historical health related data to generate a risk score for each individual. Once the risk score based on the historical health related data is generated, the risk score may be modified based on the current health related data. The process of modifying the risk score may be repeated each time a new set of current health related data is received. Modifying the risk score may include reducing the risk score or increasing the risk score based on an analysis of the current health related data that is received. Further, in some occasions the risk score may be unaltered based on the analysis of the current health data.

Each time the risk score is modified, the server may be configured to determine a cost associated with the risk represented by the risk score that is modified based on the current health data (used interchangeably as ‘modified risk score’). Further, the server may be configured to calculate a health score associated with an individual based on a combination of the modified risk score and the determined cost associated with the risk represented by the modified risk score. Upon calculation of the health score, the server may be configured to store the health score in the database associated with the server which may be accessed by authorized end users. In addition, the server may also be configured to transmit the health score to the end user upon request.

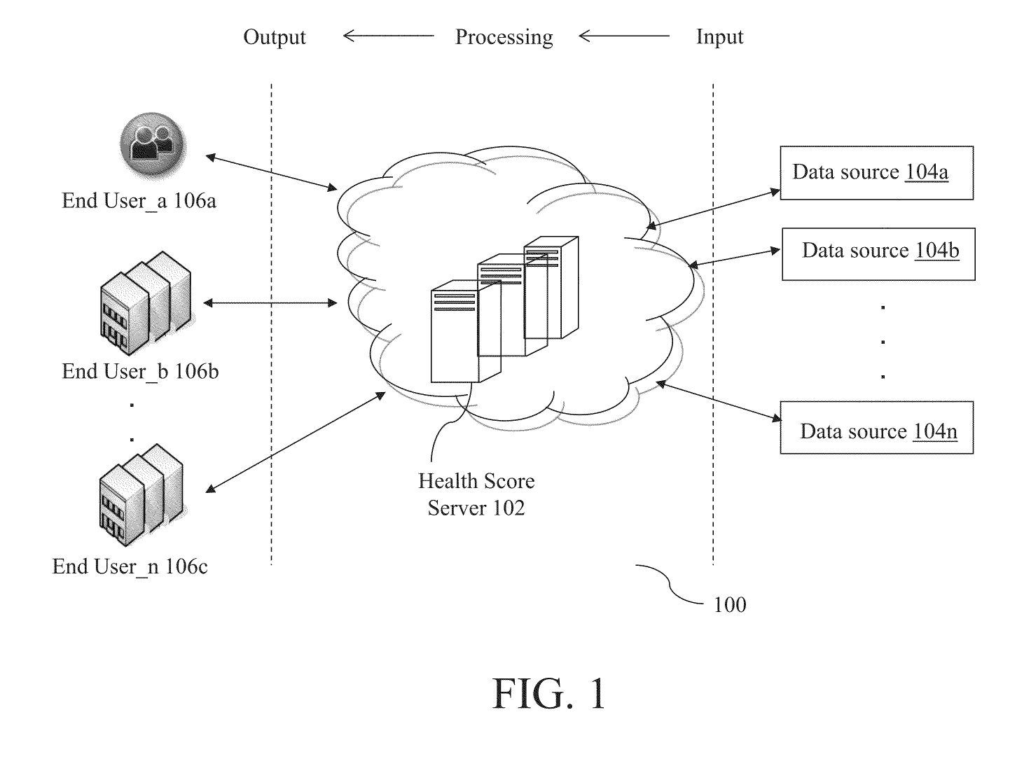

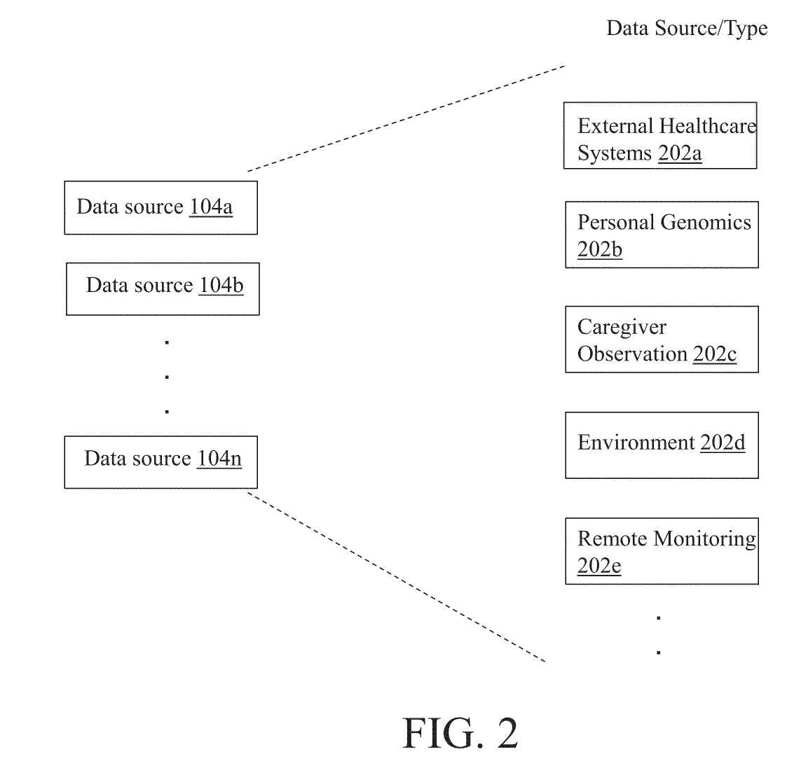

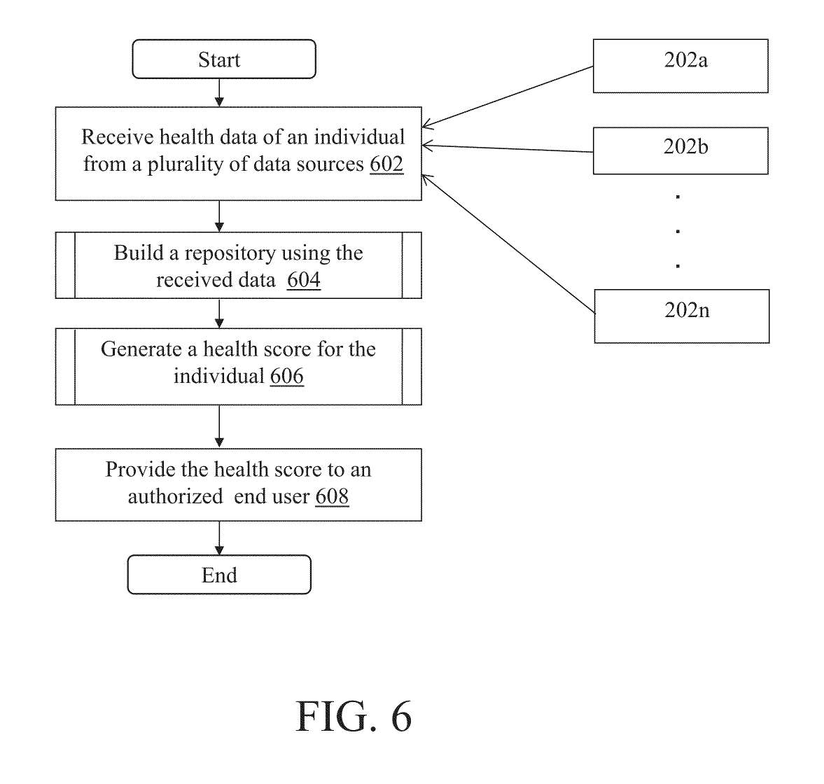

Technology for personalized health score generation will now be described in greater detail with reference to FIGS. 1-8, which describe representative embodiments of the present invention. First, FIG. 1 will be discussed in the context of describing a representative operating environment associated with personalized health score generator according to certain exemplary embodiments of the present invention. FIGS. 2-5 will be discussed, making exemplary reference back to FIG. 1 as may be appropriate or helpful. Further, the remaining FIGS. 6-8 will be discussed, making exemplary reference back to FIGS. 1-5 as may be appropriate or helpful.

The following paragraphs describe various embodiments of the personalized health score generator. It will be appreciated that the various embodiments discussed herein need not necessarily belong to the same group of exemplary embodiments, and may be grouped into various other embodiments not explicitly disclosed herein. In the following description, for purposes of explanation, numerous specific details are set forth in order to provide a thorough understanding of the various embodiments.

Further, the present invention can be embodied in many different forms and should not be construed as limited to the embodiments set forth herein; rather, these embodiments are provided so that this disclosure will be thorough and complete, and will fully convey the scope of the invention to those having ordinary skill in the art. Furthermore, all “examples” or “exemplary embodiments” given herein are intended to be non-limiting and among others supported by representations of the present invention.

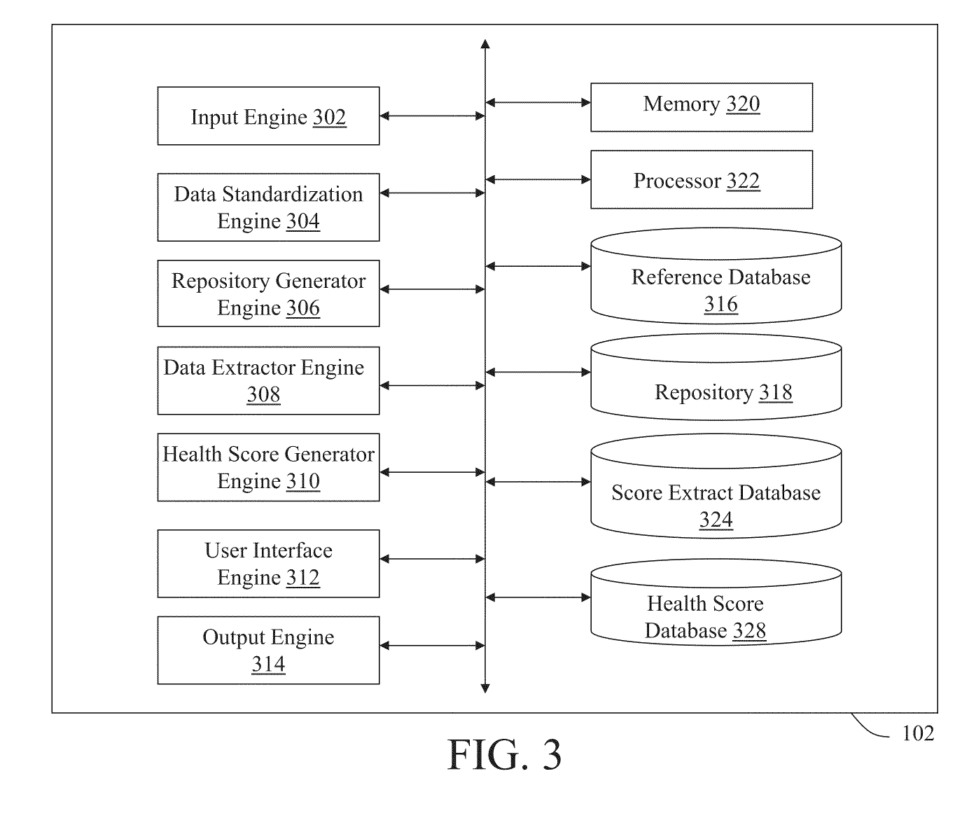

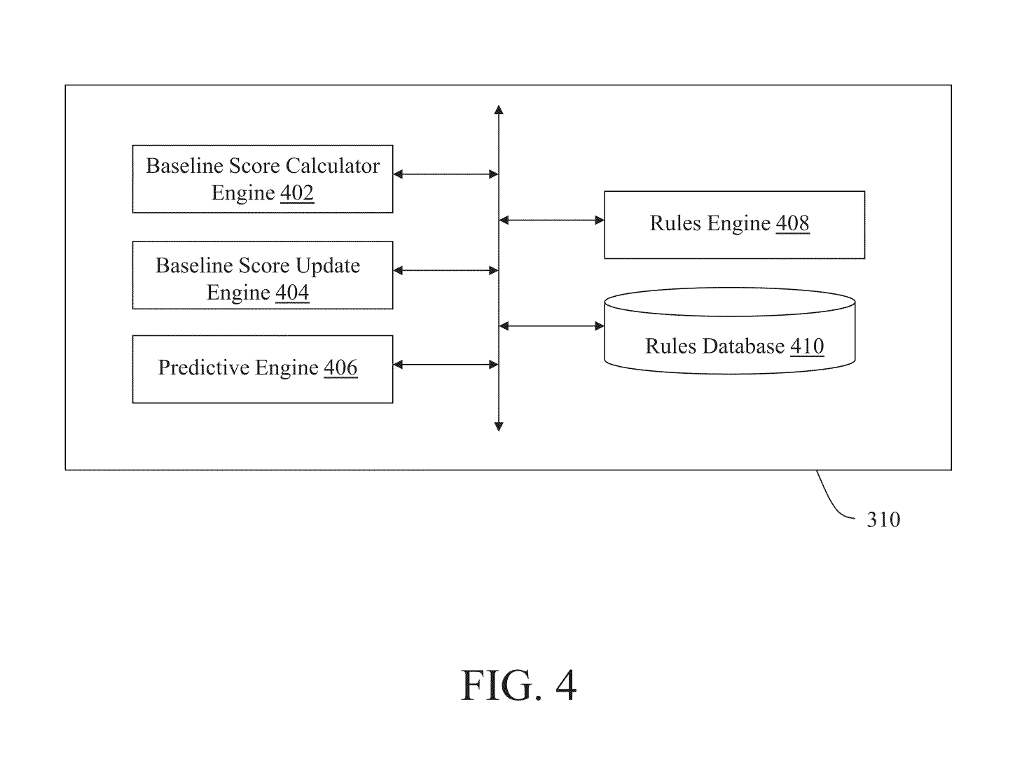

Moving now to discuss the FIGS. 1-5 further, an exemplary embodiment of the present invention will be described in detail. As further discussed below and in accordance with certain embodiments of the present invention, FIG. 1 illustrates an exemplary operational system of the personalized health score generator; while FIGS. 2 and 5 illustrates example embodiments of a the data source and the user-centric data framework respectively, and FIGS. 3-4 illustrate exemplary system elements such as a health score server.

Referring now to FIG. 1, this figure illustrates an example personalized health score generator system, according to certain exemplary embodiments of the present invention. In particular, FIG. 1 illustrates data sources 104a-n, a heath score server 102, and end users 106a-n.

In an example embodiment, the personalized health score generator system may include one or more data sources 104a-n, which may be configured to collect health related data associated with an individual and transmit the collected health related data (herein ‘health data’) to the health score server 102. In one embodiment, the data sources 104a-n may be configured to transmit the health data in batches. For example, the data sources 104a-n may be configured to collect data over a pre-defined time period and transmit the data at the end of the pre-defined time period, such transmitting the collected health data at the end of each day. The intervals at which the data sources 104a-n transmit the health data may be user-defined. In another embodiment, the data sources 104a-n may be configured to transmit the health data to the health score server 102 as and when the health data is collected, which is in near real-time. In yet another embodiment, the data sources 104a-n may be configured to transmit the collected health data upon receiving a request for the health data from the health score server 102.

In one embodiment, the data sources 104a-n may be configured to operate independent of each other, i.e., the data sources 104a-n may independently collect health data of an individual and may not communicate with each other. Further, the data collected by each of the data sources 104a-n may be in a format that is specific to the respective data source. In addition, the type of health data collected by each of the data sources 104a-n may vary based on the configuration and type of the data source 104a-n. The different types of data source and the different types of health data collected by the data sources 104a-n may be described in greater detail below, in association with FIG. 2.

Accordingly, turning to FIG. 2, this figure illustrates example input data sources associated with the personalized health score generator system, according to certain exemplary embodiments of the present invention. As illustrated in FIG. 2, the data sources 104a-n may include, but are not limited to, external healthcare system 202a, personal genomics system 202b, caregiver observation system 202c, environment data system 202d, and remote monitoring system 202e. One of ordinary skill in the art can understand and appreciate that with advancement in technology, numerous other data sources may be used for collecting health data without departing from the broader spirit of the disclosure.

As illustrated in FIG. 2, one of the data sources 104a-n may be a remote monitoring system 202e. In one example embodiment, the remote monitoring system 202e may generally refer to any appropriate system that can collect and transmit the health data of a person (hereinafter ‘individual’) at a remote location. For example, the remote monitoring system 202e as illustrated in FIG. 2 may include, but is not limited to, wearable, implanted, imbedded, and/or ingestible wireless devices. In said example, the wireless devices may be configured to collect health data of the individual and transmit the health data to a central data store (e.g., a hub) from where the collected health data can be accessed by external systems, such as the health score server 102.

The health data collected by the remote monitoring system 202e may vary from very general health data to more specific health data. For example, the health data collected by the remote monitoring system 202e may vary from measures of various physiological statistics, body temperature, body weight, blood pressure, and/or pulse oxygen levels all the way to health data associated with chronic diseases, such as cardiovascular, diabetes, orthopedics, and so on. In another example, the health data collected by the remote monitoring system 202e may include personal activity levels and data about the individuals daily routines associated with the health of the individual, such as fitness level, daily diet, etc. Further, in another example, the health data collected by the remote monitoring system 202e may include the individuals adherence to a prescribed medication program, i.e., if the individual is taking his prescribed medication, the time of day that he takes his medication, etc. One of ordinary skill in the art can understand and appreciate that above-mentioned examples of health data collected by the remote monitoring system 202e are not exhaustive, and the quantity, quality, type, and scope of health data collected may vary based on the technology associated with the remote monitoring system 202e.

In one embodiment, the remote monitoring systems 202e may be configured to collect data at regular intervals which are user-defined, for example, the remote monitoring systems 202e may be configured to collect data daily, weekly, or every 10 minutes. The refresh rate of the health data received from the remote monitoring systems 202e may be high because the remote monitoring systems 202e may include devices that may be coupled to the individual at nearly all times and are capable of consistently obtaining health data associated with the individual. For example, the remote monitoring system may be a Nike Fuelband that may be constantly worn by an individual. Further, when worn, the Nike Fuelband may be configured to obtain data related to the activity level of the individual at short intervals of every 10 minutes and store the data in a Nike server, which may then transmit the data to the health score server 102.

Moving onto another data source, the external healthcare system 202a may include systems associated with healthcare providers that store and use health data for various administrative, clinical, and/or financial functions. For example, the external healthcare system 202a can include, but is not limited to, electronic health record systems (EHR), Insurance Healthcare Claims Systems, and Specialized Care Facility Administrative Records.

Another one of the data sources 104a-n may be a caregiver observation system 202c as illustrated in FIG. 2. The caregiver observation system 202c may refer to a system that collects health data recorded by professional caregivers. In one example embodiment, health data maintained in the caregiver observation system 202c may include current observations associated with the health of an individual, wherein the current observations may be recorded by the professional caregivers in a variety of senior care, and in-patient acute care environments. In another example embodiment, health data maintained in the caregiver observation system 202c may include health data collected and documented in electronic medical records (EMR) by caregivers at various clinic and outpatient care environments.

Another source of health data may include a personal genomics system 202b as illustrated in FIG. 2. A personal genomics system 202b may refer to any appropriate system that provides a personal genomic profile of an individual. The personal genomic profile of the individual may include gene sequence data of the individual that is completely unique to the individual. In addition to uniquely identifying an individual, the personal genomic data may also provide prospective health information of the individual, such as any pre-disposition of the individual to chronic diseases, adverse medication reactions of the individual, and so on, which may help in providing appropriate treatment to the individual.

Yet another source of health data may include environment data system 202d. The environment data system 202d may include any appropriate system that may provide environmental data. In one embodiment, the environment may include an external environment of the individual that may have both a short term and long term impacts on the individual's health. For example, pollen count data, air pollution data, environment temperature data, etc. may have an impact of the individual's health. In another embodiment, the environment may include an individual's internal micro-biome environment.

Even through FIG. 2, illustrated a few representative examples of the data sources 104a-n, one of ordinary skill in the art can understand and appreciate that any appropriate additional data sources may be used to collect health data of an individual without departing from the broader scope of this disclosure.

Now turning back to FIG. 1, as described earlier, each of the data sources 104a-n may be configured to transmit the health data of the individual to the health score server 102 (herein ‘server 102’). Accordingly, the server 102 may be communicatively coupled to the one or more data providers 104a-n via a wired and/or wireless communication network. In addition, the server 102 may be communicatively coupled to the one or more end users 106a-n via a wired and/or wireless communication network In one example embodiment, the health score server 102 (herein ‘server 102’) may be a cloud based server. The server 102 may be configured to receive information from and transmit information to the one or more data sources 104a-n and/or the one or more end users 106a-n via said communication network. The information received from the one or more data sources 104a-n may include health data obtained from various systems 202a-e, as described above in association with FIG. 2. Upon receiving the health data, the server 102 may be configured to process the health data and generate a health score associated with each individual. Further, the server 102 may securely store the health score associated with each individual in a database of the server 102, which may then be accessed by any authorized end users 106a-n. For security reasons, any third party access of the health score of an individual may require authorization from the individual whose health score is being requested.

The end users 106a-n as described herein may generally refer to any appropriate party that requests the health score. The end users 106a-n may include, but are not limited to, individuals who are requesting their own health score, and or third party such as healthcare provider, healthcare insurer, self-insured employers, and institutional or commercial research centers. One of ordinary skill in the art can understand and appreciate that the list of end users provided above are not exhaustive, and may include any appropriate additional users without departing from the scope of this disclosure.

As described above, the requests for the health score may include personal inquiries by individuals, wherein each individual may want the access his or her own health score. In one embodiment, an individual may subscribe for receiving updates on his or her own health score from the server 102. Accordingly, the server 102 may be configured to transmit the current health score to the end users 106a-n when there is a change in the health score when compared to a previous health score of the individual.

Another type of request for health score may include a request from healthcare providers such as a hospital, physician, clinic, and so on. Yet another type of request for the health score may include a request from a healthcare insurer and/or a request from self-insured employers who bear the cost of their employee's health insurance. In some embodiments, the requests for the health score may include requests from research centers that may use the health score for medical research, statistical analysis, selecting participants for clinical trials, and so on.

In either case, each time the server 102 receives a request; the server 102 may be configured to generate a health score of one or more individuals whose health scores are requested. The generation of the health score by the server 102 may be described in greater detail in association with FIGS. 6-8. Before discussing the generation of the health score, the server 102 responsible for generation of the health score may be described in greater detail below, in association with FIGS. 3-5.

Turning to FIG. 3, this figure illustrates an example functional block diagram of the health score server, according to certain exemplary embodiments of the present invention. In one embodiment, the server 102 (shown in FIGS. 1 and 3) may be implemented as either as a centralized server system and/or a distributed server system using one or more data processing systems. Further, in one example embodiment, the different engines and databases illustrated in FIG. 3 and described below may be implemented using one or more computing systems (or data processing systems). The server 102 can include a web portal (e.g., web interface) through which authorized end users 106a-n and/or server and database administrators can access the server 102.

In particular, FIG. 3 illustrates that the server 102 includes, but is not limited to, an input engine 302, a data standardization engine 304, a repository generator engine 306, a data extractor engine 308, a health score generator engine 310, a user interface engine 312, an output engine 314, a memory 320, a processor 322, a reference database 316, a master repository 318, a score extract database 324, a person profile database 326, and a health score database 328.

In one embodiment, the processor 322 can be a multi-core processor. In another embodiment, the processor 322 can be a combination of multiple single core processors. In addition to the processor 322, the server 102 can include a memory 320 coupled to the processor 322. The memory 320 can be non-transitory storage medium, in one embodiment. In another embodiment, the memory 320 may be transitory medium. The memory 320 may include instruction sets which may be executed by the processor 322 to perform operations of the server 102. In other words, operations associated with the different engines 302-314 of the server 102 can be executed using the processor 322.

As illustrated in FIG. 3, the server 102 may include an input engine 302. In one embodiment, the input engine 302 may be configured to receive health data from the one or more data sources 104a-n. As described above, the health data may be received as batch data and/or in near real-time. Alternatively, the input engine 302 may be configured to systematically crawl or browse through each data source and pull health data from the data sources 104a-n. In either case, in one embodiment, the received health data may be in a format associated with the respective data source 104 from which the health data is received. In another embodiment, the health data may be formatted in the data source and therefore the health data received by the input engine 302 may already be in a format associated with the server 102. Upon receiving the health data, the input engine 302 may be configured to forward the received health data to a data standardization engine 304.

The data standardization engine 304 may be configured to receive the health data forwarded from the input engine 302. If the received health data is in a format associated with its respective data source 104, the data standardization engine 304 may be configured to translate the health data to a format associated with the server 102 such that the translated health data is compatible with the operations of the server 102. Further, the data standardization engine 304 may be configured to standardize the received health data after translation. However, if the received health data is already in a format associated with the server 102, then the data standardization engine 304 may be configured to omit the process of translating the received health data that occurs prior to standardizing the health data.

Standardizing the health data may aid in providing consistency to the health data that is received from the one or more data sources that collect health data independent of each other. For example, a first data source may record body temperature of individual X based on a rectal body temperature measurements, and a second data source may record body temperature of the individual X based on an oral body temperature measurement and the rectal body temperature. Each of these measurements may be represented by a code. If the data is analyzed without an understanding of their representative code or if unrelated data may be used in the analysis, the output of the analysis may be incorrect. In said example, if the oral body temperature measurement from the first data source is 100 F and the rectal body temperature measurement from the second data source is 102 F, a comparison of said measurements may incorrectly suggest an increase in body temperature of individual X leading to false alarms. So, in order to maintain consistency in classification of data and to avoid errors in the analysis of the data, the received health data may be standardized by the data standardization engine 304.

Standardization of the health data by the data standardization engine 304 may include comparing the received health data against a reference database 316 that comprises an universal codes for the health data and an interpretation of each code. Without being exhaustive, a few representative examples of the universal codes data included in the reference database 316 may include, Logical Observation Identifiers Names and Codes (LOINC), International Classification of Disease (ICD) Codes, Systematized Nomenclature of Medicine—Clinical Terms (SNOWMED CT), and so on. In another example embodiment, in addition to the standardized codes for medical data, the reference database 316 may also include standardized codes for non-medical data. Further, the reference database 316 may include a record of financial information and/or census data on mortality and longevity. In addition, the reference database may include records of expenses associated with addressing each health event. In other words, the reference database may include a cost associated with addressing a health or a ‘cost associated with the risk’.

In one embodiment, the server 102 may be configured to build the reference database 316 to include the cost associated with addressing any appropriate health events. Accordingly, the server 102 may be configured to receive cost related data from a plurality of cost related data sources such as health insurance/healthcare claims, prescription and non-prescription drugs, supplemental provider billing, rehabilitation services, assistive medical equipment, skilled nursing facilities, home health (medical) and home care (non-medical). One or ordinary skill in the art can understand and appreciate that the above-mentioned list of cost related data sources may not be exhaustive, and can include any other appropriate data source that can aid in determining a cost associated with addressing a health event. In one embodiment, the server 102 may be configured to process the cost related data that is received from the plurality of cost related data sources to rank each health event based on a cost associated with addressing the respective health event. In another embodiment, the server 102 may generate a cost score based on the cost related data that is received from a plurality of cost related data sources. For example, the server 102 may assign a cost score of 800 for a heart related health event, such as a congestive heart failure, and a cost score of 300 for a bone fracture event, wherein an example cost score range may be 0-1000. In said example, a higher score may indicate a higher cost of treatment associated with the corresponding health event.

Referring back to the data standardization engine 304, once the health data is standardized, the data standardization engine 304 may forward the standardized health data to the repository generator engine 306. In one embodiment, the repository generator engine 306 may be configured to categorize the data based on a user-centric data framework 500 (hereinafter ‘data framework 500’), which may be described in greater detail below in association with FIG. 5. One example of the data framework 500 (not shown in Figures) may include two categories, a first category and a second category, wherein the first category may include data that may be used to calculate a first value associated with the health of the individual and the second category may include data that may be used to modify and refine the first value for accuracy. In said example, the first value may be a risk score associated with an individual which may be modified based on the data in the second category. Another example of the data framework 500 may be described below in association with FIG. 5.

Turning to FIG. 5, this figure illustrates an example organization of data based on a user-centric data framework, according to certain exemplary embodiments of the present invention. The example data framework 500 illustrated in FIG. 5, include essentially two main categories which are a dynamic health data category 512 and a static health data category 510. Further, each category may have one or more sub categories.

As described earlier, the static health data category 510 may include data representative of a medical history data and/or non-medical history data associated with the health of an individual. For example, the static health data category 510 may include historical health factors that affect the health of an individual, such as, medical history 504b, social history 504c, family history 504d, genomics 504e, and so on, which are represented as subcategories of the static data category 510. The data represented by the subcategories 504a-e may include, but are not limited to, a major health problem in the past, history of illness, past surgical history, family diseases, childhood diseases, living arrangements, occupation, marital status, number of children, drug use history, alcohol use history, medications in the past, allergies, sexual history, and so on. In addition, the static data category 510 can include data representative of demographics 504a of an individual, such as age, gender, race, etc. One of ordinary skill in the art can understand and appreciate that the above-mentioned data is not exhaustive and are representative examples.

Further, as described earlier the dynamic health data category 512 may include any appropriate data, other than the historical health data, which provides a current perspective of the wellness and health of the individual. Accordingly the data included in the dynamic health data category can include both medical and non-medical data. As illustrated in the example embodiment of FIG. 5, the dynamic health data category 512 can include sub categories of data representative of environment factors 506a, medication taken by the individual 506b, adherence to medication process, diet and nutrition 506d, general health 506e, mental and emotional health 506g, spiritual life 506f, socialization and social activities of the individual, and so on. One of ordinary skill in the art can understand and appreciate that the above-mentioned data is not exhaustive and are representative examples.

Further, one of ordinary skill in the art can understand and appreciate that FIG. 5 illustrates a representative example of the data framework 500, and the data framework 500 may be modified to include any other types of generic and/or specific data categories that aid in the determination of a health score without departing from the broader scope of this disclosure.

Turning back to FIG. 3, once the received health data is categorized based on the data framework 500, the repository generator engine 306 may be configured to store the health data in the repository 318 within their respective categories. Once the received health data is stored, the repository 318 may be updated at regular intervals, for example, through a standard daily maintenance routine. In one embodiment, the storage size of the repository 318 may be dynamically expandable with an increase in the quantity of data. In addition to storing the health data in their respective categories, the received health data may also be stored in chronological order. Accordingly, the repository 318 may be a time-sequenced longitudinal database configured to store health data of one or more individuals.

In one embodiment, the server 102 may receive a request for health score of an individual. In another embodiment, the server 102 may be configured to automatically generate health score of an individual at regular intervals, such as at the end of each day. In either case, to generate the health score of an individual, the data extractor engine 308 of the server 102 may be configured to access the repository 318 and extract health data that is relevant to the generation of the health score of said individual. In some embodiments, all the stored health data of an individual may be relevant for generation of said individual's health score. In other embodiments, only a subset of the stored health data may be relevant for generation of the health score. The extracted health data may include the historical health data and/or the current health data of the individual.

In one embodiment, the extracted health data that is relevant to the generation of the health score may vary based from one individual to another. For example, the health data used for generation of health score for individual X that has a heart disease may be different from the health data used for generation of health score for individual Y who has lung infection. In one example embodiment, the data extractor engine 308 may be configured to extract relevant health data based on the historical health data associated with an individual. For example, consider individual X and individual Y whose health score are to be generated. Continuing with the example, if individual X has a medical history and/or a family medical history of chronic heart disease, then the data extractor engine 308 may be configured to extract health data that includes data associated with medications, exercise routine, diet and nutrition, and/or vital signs indicative of the heart performance of individual X. In contrast, if individual Y has a medical history of a chronic lung disease, then the data extractor engine 308 may be configured to extract health data that includes data associated with environment, habits such as smoking, social activities, and/or lung performance measures of individual Y, without including data associated with exercise routines, diet, and/or heart condition as in the case of individual X. One of ordinary skill in the art can understand and appreciate that other data extraction models may be used without departing from the broader scope of this disclosure.

In addition to extracting the relevant health data, the data extractor engine 308 may be configured to move the extracted data into a separate processing dataset, wherein, in one example, the processing dataset may be a longitudinally sequenced data array. Further, the data extractor engine 308 may be configured to forward the processing dataset to the health score generator engine 310, which in turn may generate a health score based on the processing dataset and/or the extracted health data. In other words, the health score generator engine 310 may be configured to generate the health score based on the historical health data and/or the current health data included in the processing dataset. The health score generator engine 310 may be described in greater detail below, in association with FIG. 4.

Turning to FIG. 4, this figure illustrates an example functional block diagram of the health score generator engine of the health score server illustrated in FIG. 3, according to certain exemplary embodiments of the present invention. In particular, FIG. 4 illustrates that the health score generator engine 310 includes, a baseline score calculator engine 402, a baseline score update engine 404, an predictive engine 406, a rules engine 408, and a rules database 410.

As described above in association with FIG. 3, the processing dataset and/or the extracted health data may include the historical health data of an individual and/or current health data of the individual that is relevant to the generation of the health score. Upon receiving the processing dataset and/or the extracted health data, the health score generator engine 310 may be configured to forward the historical health data to the baseline score calculator engine 402, and the current health data to the baseline score update engine 404.

In an example embodiment, the baseline score calculator engine 402 may be configured to receive the historical health data and generate a base risk score (initial risk score) for an individual based on the received historical health data. The baseline score calculator engine 402 may be configured to extract each data element of the received historical health data and establish the base risk score based on each data element of the received historical health data. In some embodiments, only a subset of the data elements may be used to establish the base risk score.

In one example, first the age and gender data element may be processed and a base risk score may be established based on a value associated with the age and gender data element. Then, the medical history data element may be processed and accordingly, the base risk score that is established based on the age and gender data elements may lowered if the medical history data element indicates a chronic condition.

In an additional embodiment, the base risk score may be established based rules associated with the data elements of the historical health data. For example, the rules may state that the base risk score for an individual who is 60 years old may be lower than the base risk score for an individual who is 80 years old. In another example, the rules may state that the base risk score for an individual who has a history of chronic heart disease may be higher than an individual who has a history of lung disease.

Said rules may be stored in the rules database 410. The rules database 410 and the rules engine 408 may support various score generation operations of the baseline score calculator engine 402, baseline score update engine 404, and/or the predictive engine 406. The rules database 402 may include rules associated with each data element of the historical health data and the current health data. Further, the rules stored in the rules database 410 may include simple rules and/or more complex rules, such as nested rules. These rules in the rules database 410 may be updated on a timely basis.

The rules engine 408 may be configured to receive data elements and their respective values from the baseline score calculator engine 402, baseline score update engine 404, and/or the predictive engine 406. Upon receiving the data elements and their values, the rules engine 408 may be configured to retrieve rules corresponding to the data elements. Further, the rules engine 408 may determine if the values of the data elements satisfy the rules associated with the data elements. In addition, on the basis of the outcome of the determination, the rules engine 408 may instruct the baseline score calculator engine 402, baseline score update engine 404, and/or the predictive engine 406 to set and/or modify the base risk score.

Once the base risk score is established, the baseline score update engine 404 may be configured to modify the base risk score using the current health data. In particular, the base risk score may be modified based on the value associated with each data element of the current health data. In one embodiment, the baseline score update engine 404 may be configured to determine a value of each data element associated with the current health data. Further, the baseline score update engine 404 may be configured to compare the value of each data element with a previous value of the data element to determine a change in value of the data element associated with the current health data.

In one embodiment, upon determining a change in the value associated with a data element of the current health data, the baseline score update engine 404 may be configured to modify the base risk score. In another embodiment, the base risk score may be modified based on a lack of change in value of a data element of the current health data. An example modification of the base risk score may include increasing the base risk score or decreasing the base risk score based on the change or lack of change in value of a data element associated with the current health data. For example, if a blood pressure measurement of an individual increases above a normal blood pressure level, the base risk score of the individual may be increased. Further, in said example if the blood pressure measurement of the individual decreases from a high value to a normal value then the base risk score may be decreased.

In addition to modifying the base risk score by the baseline score update engine 404, the predictive engine 406 of the server 102 may also be configured to modify the base risk score. As described above, the server 102 may forward the current health data to the predictive engine 406. Accordingly, the predictive engine 406 may be configured to receive current health data and determine if there are any health events associated with the current health data of the individual. If there are any health events, then the predictive engine 406 may be configured to retrieve previous recordings of one or more data elements of the current health data prior to the occurrence of the health event. Further, the predictive engine 406 may be configured to determine a pattern of data that lead to the health event based on the previous recorded values of one or more data elements of the current health data.

Once a pattern is determined in association with an individual, the predictive engine 406 may be configured to analyze current health data of other individuals. Further, the predicative engine 406 may be configured to compare the pattern with the current health data of the other individuals and modify a base risk score associated with the other individuals if at least a portion of the pattern approximately matches the current health data of the other individuals. In another embodiment, if the current health data of an individual approximately matches at least a portion of a data pattern associated with another individual, the base risk score of the individual may be modified, provided the data pattern of the other individual led to a health event. In some embodiments, the base risk score may be modified based on other appropriate factors in addition to the patterns of one or more data elements.

For example, if the current health data indicates that the individual X had an ischemic stroke, then the predictive engine 406 may be configured to analyze the previous recordings of relevant data elements of the current health data, such as blood pressure level, prior to the occurrence of the ischemic stroke. The predictive engine 406 may determine that the blood pressure level followed a pattern of steady increase from 120/80 to 220/110 over 2 years prior to the occurrence of the ischemic stroke. Further, the predictive engine 406 may determine a pattern of not adhering to ingestion of blood pressure medications or maintaining a low-fat diet. Once the pattern is determined, the predictive engine 406 may be configured to detect an approximate match of the pattern with a current health data of another individual Y. If the blood pressure levels of individual Y has been steadily increasing and the increase approximately matches the pattern of individual X, then the predictive engine 406 may be configured to increase the base risk score of individual Y. The predictive engine 406 may also take into consideration individual Y's adherence to intake of blood pressure medication for modifying the risk score of individual Y. In other words, if individual Y consistently takes the prescribed medicines, then the risk score may be increased by a smaller degree as compared to another individual who is inconsistent with intake of medicines. Further, if individual Y has a family history of heart diseases, then the base risk score may be increased by a higher value as compared to an absence of any heart diseases in individual Y's family history.

In an additional embodiment, the predictive engine 406 may be configured to determine data elements that are relevant for calculation of the health score. In other words, the predictive engine 406 may access the repository 324 and filter the data elements that are relevant for calculation of an individual's health score. The predictive engine 406 may be configured to determine the relevant data elements based on various factors such as historical medical data and/or previous recordings of current health data associated with an individual. Accordingly, the data elements that are relevant to the calculation of a health score may vary from one individual to another.

Turning back to FIG. 3, once the base risk score has been modified by the baseline score update engine 404 and/or the predictive engine 406, the health score generator engine 310 may access the reference database 316 to determine a cost associated with the risk indicated by the modified risk score. Further, the health score generator engine 310 may be configured to calculate the health score based on a combination of the modified base risk score and the cost associated with risk indicated by the modified base risk score. In one example embodiment, the health score may be generated based on a structured ranking of the health risk by the anticipated cost of treatment of the risk. For example, an individual Y may have a high risk for a broken bone due to lack of calcium and an individual X may have a high risk for a heart attack. In said example, the cost associated with treating a broken bone may be lesser than the cost of treating a heart attack. Accordingly, the health score generator engine 310 may assign a higher health score to individual X compared to individual Y, wherein a higher health score may indicate higher risk. In some embodiments, a higher health score may indicate a lower risk.

Once the health score is calculated, the health score generator engine 310 may store the health score in the health score database 328. The health score that is stored in the database 328 may be updated for each received current health data, wherein the current health data may be received overnight as a batch data and/or in near real-time.

In one embodiment, once the health score is stored in the database 328, the health score may be accessed by end users 106a-n (herein ‘end user 106’) based on a request from the end users 106a-n to obtain the health score. In one example, the health score may be provided to an end user 106 for a nominal fee. In another embodiment, the end user 106 may subscribe/register with the server 102 to receive updates on health scores of an individual. In either case, access may be granted based on authorization of the individual whose health score is being requested.

In one embodiment, upon receiving the request for the health score, the user-interface engine 312 may be configured to retrieve the requested health score of an individual and format the health score before presenting the health score to the requesting party via the output engine 314. Formatting the health score can include placing the health score in a format that is preferred by an end user 106, for example, in the form of a report including a numerical expression representative of the health score and factors that contribute to the health score. Further, the report may include suggestions on how the health score could be improved, i.e., how the risk score could be reduced. Further, the user-interface engine 312 may be configured to format the health score based on an authorization level associated with the end user 106. For example, authorization level associated with a health insurance company may be higher than the authorization level of a research institute. Accordingly, all the details may be made available to the health insurance company, whereas some of the data such as the individuals name and social security number may be masked or encrypted when providing a report to the research institute. The individual whose score is being requested may have full access to control the presentation of the health score.

In addition to formatting the health score and generating a report based on the health score, the user-interface engine 312 may be configured to provide a web interface through which an end user 106 may access the server 102. In one example, the end user 106 such as an individual may access the server 102 to register and subscribe for services of the server 102, such as receiving alerts each time the health score changes. In another example, the individual may access the server 102 to provide control setting associated with presentation of the health score. In yet another example, a server administer may access the server 102 for maintenance of the server 102 and or associated databases 316, 318 and/or 328. Access to the server 102 may be granted upon validation that the end user 106 requesting the access has a permission to access the server 102. Such validation may include a username and password validation, biometric validation, and so on.

In addition to accessing the health score, the server 102 may provide the end user 106 with options to run analytics on the data stored in the server 102. For example, the end user 106 can run analytics on the health data stored in the repository 318 and/or the health score database 328. For example, the end user 106 may be able to determine an average health score associated with individuals whose ages are between 60 and 70. One of ordinary skill in the art can understand and appreciate that above mentioned analytics example is not exhaustive and the server can run any appropriate analytics based on the data that is stored in the server, without departing from a broader spirit of this disclosure.

Turning now to FIGS. 6-8, these figures include flow charts that illustrate the process of personalized health score generation. Although specific operations are disclosed in the flowcharts illustrated in FIGS. 6-8, such operations are exemplary. That is, embodiments of the present invention are well suited to performing various other operations or variations of the operations recited in the flowcharts. It is appreciated that the operations in the flowcharts illustrated in FIGS. 6-8 may be performed in an order different than presented, and that not all of the operations in the flowcharts may be performed.

All, or a portion of, the embodiments described by the flowcharts illustrated in FIGS. 6-8 can be implemented using computer-readable and computer-executable instructions which reside, for example, in computer-usable media of a computer system or like device. As described above, certain processes and operations of the present invention are realized, in one embodiment, as a series of instructions (e.g., software programs) that reside within computer readable memory of a computer system and are executed by the processor of the computer system. When executed, the instructions cause the computer system to implement the functionality of the present invention as described below.

Turning to FIG. 6, this figure is a flow chart that illustrates a process of generating a personalized health score, according to certain exemplary embodiments of the present invention. In operation 602, the input engine 302 of the server 102 may receive health data of an individual from a plurality of data sources 104a-n, wherein the plurality of data sources 104a-n can include one or more systems 202a-e. In one embodiment, the health data received from the plurality of data sources 104a-n may be data source specific. In another embodiment, the data sources 104a-n may be configured to translate the data to a format compatible with the server 102 prior to transmission to the server 102.

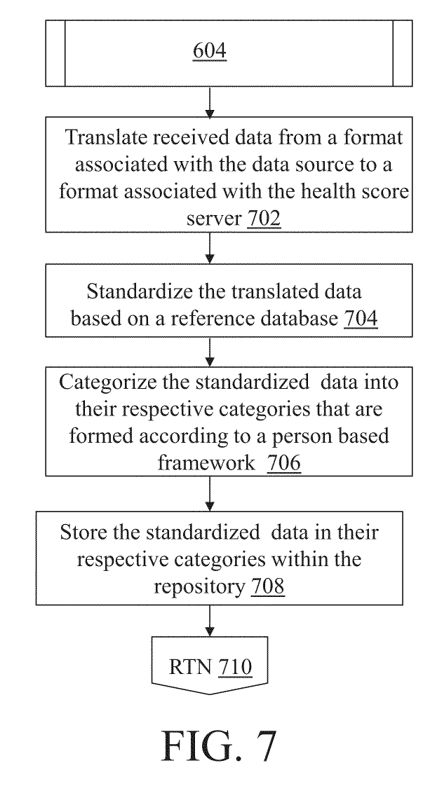

Upon receiving the health data, in operation 604 the data standardization engine 304 and the repository generator engine 306 of the server 102 may build the repository 318 by storing the received health data in the repository 318. Operation 604 may be described in greater detail below, in association with FIG. 7.

Turning to FIG. 7, this figure is a flow chart that illustrates a process of building the repository, according to certain exemplary embodiments of the present invention. Upon receiving the health data, in operation 702, the data standardization engine may convert the health data from a data source specific format to a format compatible with the server 102, provided that the received health data has not be pre-formatted into a compatible format by the data sources 104a-n. Once the health data is converted to a compatible format, the data standardization engine 304 may use the reference database 316 to standardize the health data, for example establish a consistent terminology for each data elements of the received health data.

Further, in operation 706, the repository generator engine 306 may classify the health data into one or more different categories, each of which may have one or more sub categories, based on a user-centric data framework 500. In one example embodiment, the health data may be classified into a first category and a second category, each having one or more subcategories. In said example, the first category may include health data that is used for establishing an initial risk score and the second category may include health data that may be used for modifying the initial risk score that is established based on data in the first category. In another example, the health data may be categorized into historical health data and current health data or static health data 510 and dynamic health data 512 (shown in FIG. 5). In one embodiment, each category and sub-category may be centered around the individual associated with the health data. For example, if the server 102 receives health data associated with individual X and individual Y, then, based on the user-centric data framework, the server 102 may initially classify the health data as health data belonging to individual X and health data belonging to individual Y. Further, for each individual, the server 102 may classify the health data associated with the respective individual as current health data and historical health data, each of which may have one or more sub-categories. Once the health data is classified, in operation 708, the repository generator engine 306 may store the classified data into the repository 318 within their respective categories.

As described above in association with FIG. 3, in one embodiment, the health data may be received in the form of batch data. Accordingly, as and when the health data is received at the server 102, the server 102 may repeat operations 702-708 to update the repository with the latest batch of health data. Once the health data has been classified and stored in the repository 318 or once the repository 318 has been updated, in operation 710, the server 102 may return to operation 606 of FIG. 6.

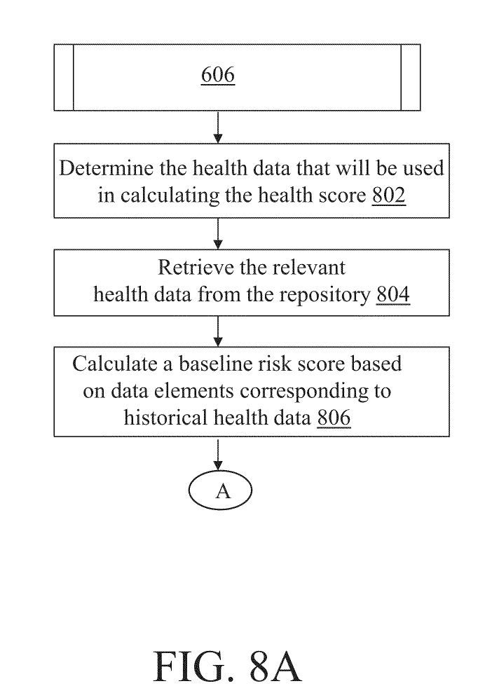

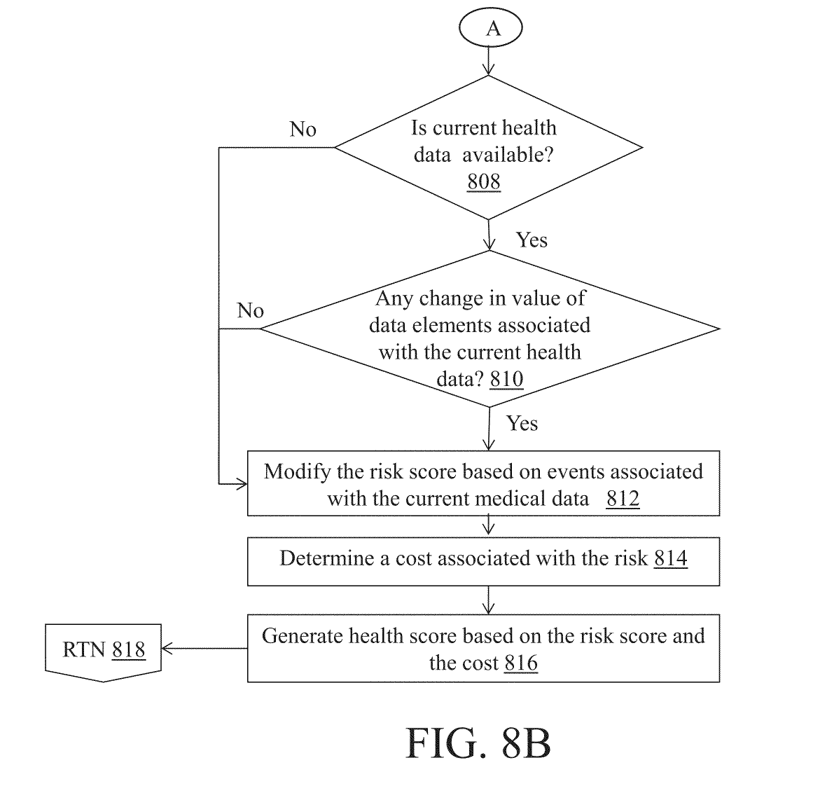

Referring back to FIG. 6, in operation 606, the health score calculator engine 310 may generate a health score of an individual based on the health data stored in the repository, which may be described in greater detail below in association with FIG. 8.

Turning to FIG. 8, this figure is a flow chart that illustrates a process of calculating the health score, according to certain exemplary embodiments of the present invention. In operation 802, the data extractor engine 308 may identify relevant health data of an individual that that may be used to generate health score of said individual. As described earlier, in one embodiment, the relevant health data used to generate the health score may vary from one individual to another. In another embodiment, the relevant health data may be identified based on a medical history associated with an individual. For example, if a medical history of an individual indicates a chronic heart disease, then the relevant health data may include any appropriate data that affects the health of the individual's heart.

Once the relevant health data is identified, in operation 804, the data extractor engine 308 may access the repository 318 and retrieve the relevant health data, which may include historical health data and/or current health data. Further, the health score generator engine 310 may forward the historical health data to the baseline score calculator engine 402, and the current health data to the baseline score update engine 404 and the predictive engine 406.

In operation 806, the baseline score calculator engine 402 may establish a risk score based on the historical risk data, such as the demographics, medical history, social history, gene structure, family medical history, and so on. In one example, the primary factors may for establishing the risk score may be age and gender related, and the risk score may further be adjusted as each new data element associated with the historical health data is processed.

Once the risk score is established and adjusted, in operation 808, the baseline score update engine 404 may determine the availability of current health data associated with the individual whose health score is being calculated. If such current health data is not available, in operation 808, the baseline score update engine 404 may modify the risk score calculated in operation 806. In some embodiments, if the current data is not available, the baseline score update engine 404 may return to operation 608 of FIG. 6. Further, in other embodiments, if the current health data is not available, the baseline score update engine 404 may continue to check the availability of current health data at regular intervals or on a continuous basis.

If the current health data is available, then in operation 810, the baseline score update engine 404 may determine the values associated with each data element of the current health data. The baseline score update engine 404 may compare the values with previously recorded values of the data elements and check if there is any change in the values. If the values have changed, in operation 812, the baseline score update engine 404 may modify the risk score that is calculated in operation 806. In some embodiments, the baseline score update engine may modify the risk score calculated in operation 806 even if the value associated with the data elements have not changed. In other words, the baseline score update engine may be configured to modify the risk score calculated in operation 806 based on a presence and/or absence of current health data. Further, if the current data is available, then the baseline score update engine 404 may modify the risk score calculated in operation 806 based on a change and/or lack of change of the values associated data elements of the current health data.

In an additional embodiment, the risk score calculated based on the historical health data may be modified by the predictive engine 406. The predictive engine 406 may analyze the current health data to determine occurrence of a health event. If the predictive engine 406 determines the occurrence of a health event associated with the current health data, the predictive engine 406 may analyze previous recordings of the current health data, i.e., recordings of the current health data prior to occurrence of the health event. Further, on the basis of the previous recordings, the predictive engine 406 may determine a pattern of data that lead to the health event. Once the pattern is determined, the predictive engine 406 may compare the pattern with current health data of other individuals. Upon detecting an approximate match between the current health data of the other individuals and at least a portion of the pattern, the predictive engine 406 may modify the risk score associated with the other individuals.

Once the risk score is modified based on the current health data, in operation 814 the score generator engine 310 may be configured to determine a cost associated with the risk that is indicated by the risk score that has been modified in operation 812. Further, in operation 816, the health score generator engine 310 may generate the health score based on a combination of the risk score that is modified by the current health data and the cost associated with the risk indicated by said risk score. For example, the health score generator engine 310 may establish a health score based on a structured ranking of one or more health risks by the anticipated cost of treatment. In addition to the health score, the health score generator engine 310 may be configured to provide a confidence level associated with the health score, wherein the confidence level may be influenced by a quantity, quality, frequency, and/or scope of the health related data based on which the health score is generated. For example, if a health score is generated based on a large quantity of high quality health related data, then the confidence level associated with the health score may be high, whereas if the health score is generated based on relatively lesser quantity and lower quality of health related data, then the confidence level may be low. Consequently, an individual may benefit from providing more health related data to the server 102, because the more willing the individual is to release his/her health related data to the health score generator system, the more likely the individual is to get a more accurate health score and a better confidence level associated with the health score. In an example embodiment, the confidence level may be represented in the form of a percentile, percentage, and/or any other appropriate numerical, textual, and/or figurative expression. Once the health score and/or the confidence interval is generated, in operation 818, the health score generator engine 310 returns to operation 608 of FIG. 6.

Referring back to FIG. 6, in operation 608, the health score and/or the associated confidence level may be stored in the health score database 328. Further, in operation 608, the server 102 may present the health score and/or the confidence level to the end user 106 via the output engine 314 upon receiving a request for the health score. Alternatively, in some embodiments, the server 102 may be configured to transmit the health score to the end user 106 upon detecting a change in the health score.

In one example, John Doe who is 50 years old Asian male may wear a wireless device that is configured to monitor John Doe's activity level (daily exercise level). Further, John Doe may be implanted with a chip that can measure statistics associated with a performance of John Doe's heart and wirelessly transmit the measurements to a central computer system. Both the wearable wireless device and the implanted chip may collect their respective measurements and transmit them to the server 102 at the end of each day. In addition to the measurements received from the wearable wireless device and the implanted chip, the server 102 may retrieve John Doe's medical history and family medical history from electronic medical records of a hospital database associated with a hospital where John Doe's primary care physician works. Additional health data associated with John Doe may be obtained from various other data sources 104a-n.

In said example, upon receiving the health data associated with John Doe, the server 102 may be configured to standardize the data and categorize the data based on a data framework that is centered around John Doe. Accordingly, John Doe's medical history, family medical history data, age, race and gender may be grouped into a first category. Further, John Doe's activity level measurements and statistics associated with the performance of John Doe's heart may be grouped into a second category.

Further, in said example, the server 102 may use the data from the first category to calculate a base risk score for John Doe. In particular, an initial base score may be generated based on John Doe's age and gender. In said example, the server 102 may set John Doe's example initial base score as 500, wherein the example risk score ranges from 0-1000. Further, the server 102 may check John Doe's medical history and family medical history. In said example, John Doe has a family medical history of congestive heart failure and lung diseases. Accordingly, the server may increase the initial base risk score to 700. If there are no other medical history and/or family medical history data that affects the base risk score, then the server 102 sets John Doe's final base risk score as 700.

Once the base risk score is set, the server 102 may process data from the second category, i.e., the activity level measurements and the statistics associated with the performance of John Doe's heart (herein statistics data). Further, the server 102 may determine if the activity level measurement and statistics data obtained currently differ from the last recorded measurements. Suppose the John Doe's activity level measurement indicates that John Doe has exercising more often, the server 102 may reduce the example base risk score to 550 from 700. However, if the statistics data shows that the John Doe's resting heart rate is 90-100, which is higher than a normal resting heart rate, the server 102 may increase the last modified example risk score of 550 to 580. Further, if the statistics data associated with John Doe's heart's performance approximately matches a portion of a data pattern of statistics data associated with another individual that had a heart attack, then the predictive engine of the server 102 may further increase the example risk score from 580 to 590. In said example, the degree of modification of the risk score may be based on the data present in the first category, i.e., medical history and/or family medical history of John Doe. In other words, if John Doe did not have a family medical history of heart diseases, then even though John Doe's resting heart rate is high, the risk score may be increased by a smaller margin. Eventually, after the server 102 has gone through each data in the second category, the server 102 may set the example risk score as 600.

In said example, the risk score may indicate a predicted risk of manifestation of a heart disease and a lung disease in John Doe. Once the risk score has been set based on the data from the second category, the server 102 may determine a cost associated with treating the anticipated heart disease. Such cost data may be obtained from health insurance claims and/or other external databases. Once the cost has been determined, the server 102 may determine a health score based on the example risk score of 600 and the associated cost. In some embodiment, the cost may be assigned a score as well, for example the cost may be scored from 0-100, wherein a cost score of 100 may indicate a higher cost or vice versa. Later, the health score may be generated based on the risk score and/or the cost score. In said example, the health score may have a different scale than the risk score, and accordingly, the John Doe's example health score may be set at 328, where the example health score ranges from 0-500. In another example, the health score may be may have the same scale as that of the risk score and/or the cost score. In addition to the health score, the server 102 may be configured to provide a confidence level associated with the health score. For example, John Doe's health score of 328 may be provided with a 98% confidence level.

Later, Jane Roe who is associated with a health insurance entity may request the server 102 to provide Jane Roe with John Doe's health score. In one embodiment, Jane Roe may access the server 102 through a web interface. To access the server 102, Jane Roe may have to be a registered user of the server 102. Upon trying to access the server 102, Jane Roe may be asked to identify herself using a username and a password, or a biometric scan. If Jane Roe is recognized as a registered user, Jane Roe may be granted entry to into the server 102. Upon accessing the server 102, Jane Roe may be provided with an option to request for John Doe's health score. Upon receiving the request, the server 102 may be configured to retrieve John Doe's health score and present it to Jane Roe provided John Doe has authorize Jane Roe to access John Doe's health score. In addition to Jane Roe, John Doe may also be able to register with the server 102 for updates on John Doe's health score. Further, in some embodiments, each of them may be provided options to run other analytics on the data that is stored in the server 102. For example, John Doe may decide to check the average health score of all the 50 years old Asian males.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or in Digital Signal Processor (DSP) circuitry).

The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
receiving, at a server, health related data of a user from a plurality of sources;
aggregating, by the server, the health related data received from the plurality of sources;
generating, by the server, a health score for the user based on the aggregated health related data; and
providing, by the server, access to the health score.

2. The method of claim 1, wherein aggregating the health related data further comprises standardizing, by the server, the health related data received from the plurality of sources based on a reference database.

3. The method of claim 1, wherein aggregating the health related data comprises categorizing, by the server, the health related data based on a user-centered data framework.

4. The method of claim 3, wherein the health related data is categorized into a category of historical health related data and a category of current health related data based on user-centered data framework.

5. The method of claim 1, wherein generating the health score further comprises:
calculating, by the server, a risk score for the user based on a historical health related data of the user;
modifying, by the server, the risk score of the user based on a current health related data of the user; and
determining, by the server, a cost associated with a risk represented by the risk score that is modified by the current health related data of the user.

6. The method of claim 5, wherein the risk score is modified based on a change in value associated with a data element of the current health data.

7. The method of claim 5, wherein the risk score is modified based on a lack of change in value associated with the data element of the current health data.

8. The method of claim 5, further comprising generating the health score based on the risk score that is modified by the current health data and the cost associated with the risk represented by the risk score that is modified by the current health data.

9. An apparatus, comprising:
a memory comprising a set of instructions; and
a processor coupled to the memory and configured to execute the set of instructions to:
receive health related data of a user from a plurality of sources;
categorize the health related data into a category of historical health related data and a category of current health related data;
generate a health score for the user based on the historical health related data and the current health related data; and
transmit the health score for presentation.

10. The apparatus of claim 9, wherein the processor is configured to standardize the health related data received from the plurality of sources based on a reference database.

11. The apparatus of claim 9, wherein to generate the health score the processor is configured to:
calculate a base risk score for the user based on the historical health related data of the user; and
modify the base risk score of the user based on the current health related data of the user; and
determine a cost associated with a risk represented by the modified risk score.

12. The apparatus of claim 9, wherein the health score is generated based on a combination of the modified risk score and the cost associated with the risk represented by the modified risk score.

13. The apparatus of claim 11,
wherein the processor is configured to modify the base risk score based on at least one of a change in value of a data element associated with the current health related data and a lack of change in value of the data element associated with the current health related data.

14. A system comprising:
a communication network; and
a computer coupled to the communication network and configured to:
receive health related data of a user from a plurality of sources;
aggregate the health related data received from the plurality of sources in a database; and
generate a health score for the user based on the health related data that is aggregated in the database.

15. The system of claim 14, wherein the computer is configured to:
change a format of the health related data from a format associated with a respective source of the plurality of sources to a format associated with the computing device;
standardize the health related data received from the plurality of sources based on a reference database; and
organize the standardized health related data into a first category of the health related data and a second category of the health related data.

16. The system of claim 15, wherein the computer is configured to:
calculate a base risk score for the user based on the first category of the health related data; and
modify the base risk score of the user based on the second category of the health related data; and
determine a cost associated with a risk represented by the modified risk score.

17. The system of claim 16, wherein the first category of the health related data comprises a historical health related data.

18. The system of claim 16, wherein the second category of health related data comprises a current health related data.

19. The system of claim 17, wherein the computer is configured to calculate the health score based on the modified risk score and the cost associated with the risk represented by the modified risk score.

20. The system of claim 18, wherein the computer is configured to modify the base risk score based on at least one of a change in value of a data element associated with the current health related data and a lack of change in value of the data element associated with the current health related data.
